(19) United States
(12) Patent Application Publication
(10) Pub. No.: US 2004/0166295 A1
(43) Pub. Date: Aug. 26, 2004

(54) Recording medium, image forming process using the recording medium and production process of the recording medium

(75) Inventors: Katsutoshi Misuda, Kanagawa (JP); Masanobu Asaoka, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/787,080

(22) Filed: Feb. 27, 2004

Related U.S. Application Data
(62) Division of application No. 09/945,760, filed on Sep. 5, 2001, now abandoned.

(30) Foreign Application Priority Data
Sep. 7, 2000 (JP) 2000-272051

(51) Int. Cl. B32B 3/00

(52) U.S. Cl. 428/195.1

(57) ABSTRACT

Disclosed herein is a recording medium comprising a base material and an ink-receiving layer containing a particulate material provided on the base material, wherein the particulate material comprises aluminum oxide particles of the γ-crystal structure, the average particle diameter of the aluminum oxide particles is at least 0.21 μm, but at most 1.0 μm, at least 90% of all the aluminum oxide particles have a particle diameter of at most 1.0 μm, and the specular glossiness of the surface of the ink-receiving layer is at least 50% as measured at 75°.

### BACKGROUND OF THE INVENTION

1. Field of the Invention

The present invention relates to a recording medium, a production process of the recording medium, and an image forming process using this medium.

2. Related Background Art

An ink-jet recording system is a system in which minute droplets of an ink are ejected by any one of various operation principles to apply them to a recording medium such as paper, thereby making a record of images, characters and/or the like, has such features that recording can be conducted at high speed and with a low noise, multi-color images can be formed with ease, printing patterns are very flexible, and development is unnecessary; and is hence developed into information instruments led by printers and including copying machines, word processors, facsimiles and plotters, so that it is rapidly widespread.

In recent years, high-performance digital cameras, digital video cameras and scanners have begun to be provided cheaply, and occasion to output image information obtained from such instruments by an ink-jet recording system has increased conjointly with the spread of personal computers. Therefore, there is a demand for outputting images comparable in quality with silver halide photographs and multi-color prints by a plate making system by an ink-jet system.

Improvements in recording apparatus and recording systems, such as speeding up and high definition of recording, and full-coloring of images, have thus been made, and recording media have also been required to have higher properties.

With respect to recording media used in ink-jet recording and the like, a wide variety of recording media has heretofore been proposed. For example, Japanese Patent Application Laid-Open No. 52-53012 discloses paper for ink-jet, in which a base paper web having a low sizing degree is impregnated with a surface coating. Japanese Patent Application Laid-Open No. 53-49113 discloses paper for ink-jet, in which a sheet containing urea-formalin resin powder therein is impregnated with a water-soluble polymer. Japanese Patent Application Laid-Open No. 55-5830 discloses paper for ink-jet recording, in which a coating layer having good ink absorbency is provided on a surface of a base material. Japanese Patent Application Laid-Open No. 55-51583 discloses an example in which non-crystalline silica is used as a pigment in a coating layer. Japanese Patent Application Laid-Open No. 55-146786 discloses an example in which a coating layer formed of a water-soluble polymer is used.

In recent years, attention has been attracted to recording media using an alumina hydrate because such a recording medium has such advantages, compared with the conventional recording media, that a dye in an ink is well fixed thereto, since the alumina hydrate has a positive charge, and an image high in coloring and gloss is hence provided.

For example, U.S. Pat. Nos. 4,879,166 and 5,104,730, and Japanese Patent Application Laid-Open Nos. 2-276670, 4-37576 and 5-32037 disclose recording media in which a layer containing an alumina hydrate of a pseudoboehmite structure is used as an ink-receiving layer. Such pseudoboehmite can be produced by any conventional method such as the hydrolysis of an aluminum alkoxide or sodium aluminate. In the case of a recording medium produced by using the pseudoboehmite obtained by such a method in a coating formulation, it can be provided a recording medium better in fixing of a dye in an ink and high in coloring ability and gloss compared with the conventional recording media.

On the other hand, Japanese Patent Application Laid-Open No. 10-129112 describes a sheet for ink-jet in which an ink-receiving layer using fine aluminum oxide particles of the γ-crystal structure having an average particle diameter of at most 200 nm is formed on a base material of a synthetic resin sheet.

The present inventors have carried out an extensive investigation with a view toward more improving the surface strength of a receiving layer of a recording medium having a layer containing alumina hydrate typified by pseudoboehmite to provide a recording medium having recording properties comparable with the above recording medium using crystalline aluminum oxide particles. The present inventors have paid attention to aluminum oxide particles (hereinafter referred to as γ-alumina) having the γ-crystal structure. However, the conventionally sold γ-alumina particles have been subjected to a sintering step in their production process, and so only particles having a great particle diameter have been provided due to their aggregation during the sintering step, although these particles have comparatively high hardness. Therefore, any recording medium comprising the conventional α-alumina as a main component is low in gloss, and so only a substantially dull image has been able to be provided. When the surface of such a recording medium has been subjected to a physically smoothing treatment by a calender or the like to impart high gloss, the gloss has been somewhat improved, but the recording medium thus treated has involved a problem that the ink absorbency thereof is deteriorated.

### SUMMARY OF THE INVENTION

The present invention has been made with the foregoing circumstances in view, and its object is to provide a recording medium which has an ink-receiving layer formed mainly of crystalline aluminum oxide particles, is excellent in ink absorbency and gloss and can provide an image high in image density, and a production process of the recording medium.

The above object can be achieved by the present invention described below.

According to the present invention, there is thus provided a recording medium comprising a base material and an ink-receiving layer containing a particulate material provided on the base material, wherein the particulate material comprises aluminum oxide particles of the γ-crystal structure, the average particle diameter of the aluminum oxide particles is at least 0.21 μm, but at most 1.0 μm, at least 90% of all the aluminum oxide particles have a particle diameter of at most 1.0 μm, and the specular glossiness of the surface of the ink-receiving layer is at least 50% as measured at 75°.

According to the present invention, there is also provided an image forming process, comprising the step of applying a recording liquid to the ink-receiving layer of the recording medium described above according to recording information to form an image.

According to the present invention, there is further provided a process for producing a recording medium, which comprises the steps of forming coarse particles of γ-alumina by heating and calcining boehmite or pseudoboehmite, removing a coarse particle component by a separating treatment after grinding the formed coarse particles of γ-alumina, and applying the γ-alumina particles, from which the coarse particle component has been removed, onto a base material.

### DESCRIPTION OF THE PREFERRED EMBODIMENTS

The recording medium according to the present invention comprises a base material and an ink-receiving layer containing γ-alumina and a binder optionally used on the base material. The γ-alumina used in the present invention is ground and then subjected to a treatment for removing a coarse particle component, thereby adjusting it so as to have a specific average particle diameter and a particle size distribution. The use of such γ-alumina permits providing an ink-receiving layer having a glossiness of at least 50% as measured at 75° and an excellent ink absorbency.

The γ-alumina particles used in the present invention are such that the average particle diameter is at least 0.21 μm, but at most 1.0 μm, preferably at most 0.5 μm, and that at least 90% of all particles of the γ-alumina have a particle diameter of at most 1.0 μm. In the present invention, the particle size distribution is a value measured by means of a particle size distribution meter (LS230, trade name, manufactured by Coulter Co.). If the average particle diameter exceeds 1.0 μm, or the conditions that at least 90% of all particles of the γ-alumina have a particle diameter of at most 1.0 μm are not satisfied even when the average particle diameter is at most 1.0 μm, the desired glossiness cannot be achieved. In addition, a problem that no sufficient coloring ability is achieved arises because scattering of light in the resulting ink-receiving layer becomes great. If the average particle diameter is smaller than 0.21 μm, high color density and glossiness are achieved, but the ink absorbency of the resulting ink-receiving layer is deteriorated, and so in some images an ink may overflow to mix it with another dot, thereby lowering the clearness or evenness of the image. Therefore, such a recording medium is not suitable for use in full-color recording. This problem is particularly marked in a photoprinter because a great amount of inks are applied at a short time interval. Incidentally, the term “photoprinter” as used herein means a generic term of printers capable of forming images comparable with silver halide photographs.

In the recording medium according to the present invention, the binder used in combination with the γ-alumina may be freely selected from among water-soluble polymers. For example, preference may be given to polyvinyl alcohol or modified products thereof, starch or modified products thereof, gelatin or modified products thereof, casein or modified products thereof, gum arabic, cellulose derivatives such as carboxymethyl cellulose, hydroxyethyl cellulose and hydroxypropyl methyl cellulose, conjugated diene copolymer latexes such as SBR latexes, NBR latexes and methyl methacrylate-butadiene copolymers, functional-group-modified polymer latexes, vinyl copolymer latexes such as ethylene-vinyl acetate copolymers, polyvinyl pyrrolidone, maleic anhydride polymers or copolymers thereof, acrylic ester copolymers, and the like. These binders may be used either singly or in any combination thereof.

A mixing ratio by weight of the γ-alumina to the binder is preferably 1:1 to 30:1, more preferably 1:1 to 25:1. If the amount of the binder is less than the lower limit of the above range, the mechanical strength of the resulting ink-receiving layer is lowered, which forms the cause of cracking and dusting. If the amount of the binder is greater than the upper limit of the above range, the pore volume of the resulting ink-receiving layer is reduced, resulting in a recording medium poor in ink absorbency.

The γ-alumina used in the present invention can be obtained by heating and calcining boehmite or pseudoboehmite produced by any conventional method such as the hydrolysis of an aluminum alkoxide or sodium aluminate at a temperature of, for example, 400 to 600° C. The γ-alumina particles obtained by this method are particles high in hardness. The formation of an ink-receiving layer composed mainly of such particles is preferred from the viewpoint of formation of an ink-receiving layer high in surface strength. However, the γ-alumina particles formed in the above-described manner generally have a particle diameter at the micron size scale, since they have undergone aggregation in the calcination. In the present invention, such coarse particles of the γ-alumina are treated to adjust their average particle diameter and particle size distribution to the desired values. The γ-alumina before the treatment is preferably in the form of flake or needle as the form of primary particles. When an ink-receiving layer is formed by using the γ-alumina obtained in the above-described manner, the resultant ink-receiving layer is high in ink absorbency and dye-fixing ability, and hard to cause cracking upon the formation of a film. As the γ-alumina of a starting material, may also be used commercially available particles.

A specific process for forming the γ-alumina particles according to the present invention from coarse particles of γ-alumina is the following process.

γ-Alumina of a starting material is first dispersed in purified water while conducting agitation. Since the particle diameter of such γ-alumina generally exceeds 1 μm, it tends to precipitate when it is left to stand without conducting agitation. A dispersing agent may be used if necessary. As the dispersing agent, is preferred an acid such as hydrochloric acid, nitric acid or acetic acid, or a surfactant.

Thereafter, a grinding treatment is conducted. An ultrasonic treatment, a treatment by a homogenizer, a treatment by a ball mill, a treatment by a nanomizer or the like may be used in the grinding treatment.

Finally, coarse particles at the micron size scale are removed by a separating treatment to give the desired average particle diameter and particle size distribution. As a method therefore, may be used a method in which a supernatant is taken out by stationary sedimentation, a method by centrifugation, a method by a filter such as ultrafiltration, or the like.

In addition to the γ-alumina particles, particles of the conventionally known inorganic pigment, organic pigment or the like may be contained in the particulate material used in the formation of the ink-receiving layer within limits not impeding the properties inherent in the γ-alumina layer as needed. In the present invention, the ink-receiving layer is preferably formed by the γ-alumina particles in an amount of at least 70% by weight, more preferably at least 90% by weight based on all particles.

The BET specific surface area of the γ-alumina used in the present invention is preferably within a range. of from 70 to 300 m²/g, preferably from 100 to 160 m²/g. If such a BET specific surface area is smaller than the lower limit of the above range, the pore distribution of the resulting ink-receiving layer is biased to larger pores, and so a dye in an ink may not be sufficiently adsorbed and fixed in some cases. In addition, irregular reflection may be caused by internal pores to deteriorate the color density of an image formed thereon. If the BET specific surface area is greater than the upper limit of the above range on the other hand, such γ-alumina may not be coated with good dispersibility, and so the resulting ink-receiving layer tends to fail in control of its pore distribution, and sufficient ink absorbency and gloss are hard to be achieved.

To a coating formulation for forming the ink-receiving layer, as needed, may be added a dispersing agent, thickener, pH adjuster, lubricant, flowability modifier, surfactant, antifoaming agent, water-proofing agent, parting agent, fluorescent whitening agent, ultraviolet absorbent, antioxidant and/or the like in addition to the γ-alumina and binder.

The glossiness of a surface on the side of the ink-receiving layer of the thus-obtained recording medium according to the present invention is controlled so as to be at least 50% as measured at 75°. The glossiness in the present invention is a value measured in accordance with the method prescribed in JIS Z 8741.

The base material of a fibrous material used in the present invention is a base material composed mainly of wood pulp and a filler and preferably has a basis weight of at least 120 g/m² for the purpose of imparting a texture like a silver halide photograph. A range of from 150 to 180 g/m² is more preferred because a recording medium having a feeling of higher grade can be provided even in the size of the order of A4 to A3. It is also desirable that the Stöbkigt sizing degree thereof be preferably at least 100 seconds, more preferably at least 200 seconds. The reason for it is that since the absorption of an ink applied is almost conducted in the layer containing the γ-alumina, the absorption property of the base material itself is not required to a high extent, and the base material is rather required to have a good back surface, section and the like.

In order to make the whiteness degree of the base material good, it is preferable to form a surface layer containing barium sulfate on at least one side of the base material. A coating weight on the base material is preferably within a range of from 20 to 40 g/m² for imparting smoothness. No particular limitation is imposed on the coating and drying methods. However, it is preferred that a surface-smoothing treatment such as calendering be conducted as a finishing step, and the whiteness degree and Bekk smoothness of the surface be at least 87% and at least 400 seconds, respectively.

In the recording medium having the ink-receiving layer according to the present invention, as a method for forming the ink-receiving layer on the base material, may be used a method of coating the base material with a dispersion containing the γ-alumina by means of a coating device and drying it. As the coating method, may be used a generally-used coating technique making use of a blade coater, air knife coater, roll coater, curtain coater, bar coater, gravure coater, sprayer or the like. The coating weight of the dispersion is preferably within a range of from 0.5 to 60 g/m², preferably 5 to 45 g/m² in terms of dry solids content. After the-coating, the surface smoothness of the resulting ink-receiving layer may also be improved by means of a calender machine or the like as needed.

The present invention will hereinafter be described more specifically by the following Examples. However, the present invention is not limited to these examples. The measurements of physical properties were conducted in accordance with the following respective methods. Incidentally, all designations of “part” or “parts” as will be used in the following examples mean part or parts by weight unless expressly noted.

(1) Particle Size Distribution:

A reagent with 2 cc of a γ-alumina dispersion added to 50 cc of purified water was prepared to conduct measurement by means of a particle size distribution meter (LS230, trade name, manufactured by Coulter Co.).

(2) Image Density:

Using yellow (Y), magenta (M), cyan (C) and black (Bk) inks each having the following ink composition 1, solid printing was conducted to evaluate the image density of an image formed by each ink by means of a Macbeth reflection densitometer RD-918.

(3) Surface Glossiness (Measured at 75°):

Evaluation was conducted by means of a digital variable angle glossmeter (manufactured by Suga Shikenki K.K.) in accordance with the method prescribed in JIS Z 8741.

(Ink Composition)

| | |
|---|---|
| Dye | 5 parts |
| Ethylene glycol | 10 parts |
| Polyethylene glycol | 10 parts |
| Water | 75 parts. |

(Dye)

Y: C.I. Direct Yellow 86

M: C.I. Acid Red 35

C: C.I. Direct Blue 199

Bk: C.I. Food Black 2.

### EXAMPLE 1

Aluminum octoxide was synthesized in accordance with the process described in U.S. Pat. Nos. 4,242,271 and 4,202,870. The aluminum octoxide was then hydrolyzed to prepare an alumina slurry. The alumina slurry was then subjected to a post treatment such as drying to obtain powdery pseudoboehmite. This powder was calcined for 2 hours in an oven controlled at 500° C. to obtain γ-alumina. The median of particle size distribution at this time was 20 μm. This γ-alumina was dispersed in purified water at a concentration of 20% by weight by using acetic acid as a dispersing agent. The resultant dispersion was then treated for 60 minutes by means of an ultrasonic dispersing machine, and coarse particles were removed from the dispersion by a centrifugal separating treatment to obtain treated γ-alumina. The data of the γ-alumina treated are shown in Table 1.

In order to measure a glossiness of a recording medium comprising this treated γ-alumina as a main component, the treated γ-alumina and an aqueous solution of completely saponified polyvinyl alcohol (PVA-117, trade name, product of Kuraray Co., Ltd.) were mixed and stirred so as to give a weight ratio of the treated γ-alumina to the polyvinyl alcohol of 10:1 in terms of solids, thereby obtaining Dispersion 1.

Dispersion 1 was applied by a bar coating process on to a surface of a base material (Bekk smoothness: 420 seconds; whiteness degree: 89%) having a surface layer containing barium sulfate so as to give a dry coating weight of 40 g/m², and dried. The base material used at this time was obtained by coating a fibrous base having a basis weight of 150 g/m² and a Stökigt sizing degree of 200 seconds with a baryta composition composed of 100 parts of barium sulfate and 10 parts of gelatin so as to give a dry coating weight of 30 g/m² and subjecting it to a calendering treatment. Recording Medium 1, in which an ink-receiving layer was formed on the base material having the baryta layer, was produced in the above-described manner.

The surface of this recording medium had gloss. The optical density of an image formed on this recording medium and the glossiness thereof were measured in accordance with the above-described respective methods. The results are shown in Table 1.

### EXAMPLE 2

Aluminum octoxide was synthesized in accordance with the process described in U.S. Pat. Nos. 4,242,271 and 4,202,870. The aluminum octoxide was then hydrolyzed to prepare an alumina slurry. The alumina slurry was then subjected to a post treatment such as drying to obtain powdery pseudoboehmite. This powder was calcined for 2 hours in an oven controlled at 500° C. to obtain γ-alumina. The median of particle size distribution at this time was 20 μAm. This γ-alumina was dispersed in purified water at a concentration of 20% by weight by using acetic acid as a dispersing agent. The resultant dispersion was then treated for 40 hours by means of a ball mill, and coarse particles were removed from the dispersion by a centrifugal separating treatment to obtain treated γ-alumina. The data of the γ-alumina treated are shown in Table 1. Recording Medium 2 was produced in the same manner as in EXAMPLE 1 except that the γ-alumina obtained by the above process was used, to conduct a test. This Recording Medium 2 also had gloss. The optical density of an image formed on this recording medium and the glossiness thereof were measured in accordance with the above-described respective methods. The results are shown in Table 1.

### EXAMPLE 3

The same treatment as in EXAMPLE 2 was carried out except that the treatment by means of a ball mill was conducted for 30 hours to obtain treated γ-alumina. The data of the γ-alumina treated are shown in Table 1. Recording Medium 3 was produced in the same manner as in EXAMPLE 1 except that the γ-alumina obtained by the above process was used, to conduct a test. This Recording Medium 3 also had gloss. The optical density of an image formed on this recording medium and the glossiness thereof were measured in accordance with the above-described respective methods. The results are shown in Table 1.

### COMPARATIVE EXAMPLE 1

A commercially available γ-alumina (AKP-G015, trade name, product of Sumitomo Chemical Co., Ltd.) was used as it is and dispersed in purified water at a concentration of 20% by weight by using acetic acid as a dispersing agent. An alumina dispersion obtained in the same manner as in EXAMPLE 1 except that neither the treatment by the ultrasonic dispersing machine nor the removal of coarse particles by the centrifugal separating treatment was conducted was used as an alumina dispersion. The median of particle size distribution AKP-G015 was 2.4 μm. Recording Medium 4 was produced in the same manner as in EXAMPLE 1 except that this dispersion was used, to conduct a test. The data of the γ-alumina are shown in Table 1. The optical density of an image formed on this recording medium and the glossiness thereof were measured. The measurement results are shown in Table 1. No surface gloss was observed.

### COMPARATIVE EXAMPLE 2

AKP-G015 used in COMPARATIVE EXAMPLE 1 was used as it is and dispersed in purified water at a concentration of 20% by weight by using acetic acid as a dispersing agent. An alumina dispersion obtained in the same manner as in EXAMPLE 1 except that only the treatment by the ultrasonic dispersing machine was conducted, and the removal of coarse particles by the centrifugal separating treatment was not conducted was used as an alumina dispersion. Recording Medium 5 was produced in the same manner as in EXAMPLE 1 except that this dispersion was used, to conduct a test. The data of the γ-alumina after the treatment are shown in Table 1. The optical density of an image formed on this recording medium and the glossiness thereof were measured. The measured values are shown in Table 1. Surface gloss was somewhat observed, but its value was not very great.

### COMPARATIVE EXAMPLE 3

Recording Medium 6 was produced in the same manner as in EXAMPLE 1 except that the γ-alumina used in EXAMPLE 1 was subjected to only the treatment by the ultrasonic dispersing machine, to conduct a test. The data of the γ-alumina after the treatment are shown in Table 1. The optical density of an image formed on this recording medium and the glossiness thereof were measured. The measured values are shown in Table 1. No surface gloss was observed.

TABLE 1

| | | | | | | | Average | Particle diameter at |
|---|---|---|---|---|---|---|---|---|
| | | | | | | | particle | 90% from the smallest |
| | | Optical density | | | | Glossiness | diameter | in particle size |
| | | Bk | C | M | Y | at 75° (%) | (μm) | distribution (μm) |
| EX. 1 | Recording | 2.11 | 2.09 | 1.85 | 1.87 | 52.0 | 0.30 | 0.83 |
| | Medium 1 | | | | | | | |
| EX. 2 | Recording | 2.20 | 2.15 | 1.88 | 1.90 | 60 | 0.24 | 0.51 |
| | Medium 2 | | | | | | | |
| EX. 3 | Recording | 2.10 | 2.05 | 1.80 | 1.82 | 50.0 | 0.50 | 0.95 |
| | Medium 3 | | | | | | | |
| COMP. | Recording | 1.90 | 1.89 | 1.68 | 1.79 | 15 | 2.43 | 4.32 |
| EX. 1 | Medium 4 | | | | | | | |
| COMP. | Recording | 2.00 | 1.95 | 1.77 | 1.80 | 30.0 | 1.23 | 2.61 |
| EX. 2 | Medium 5 | | | | | | | |
| COMP. | Recording | 1.95 | 1.80 | 1.75 | 1.75 | 20.3 | 1.54 | 3.21 |
| EX. 3 | Medium 6 | | | | | | | |

The recording media according to the present invention each have an ink-receiving layer improved in surface strength and having high gloss, and so images comparable in quality with silver halide photographs and prints by a plate making system can be provided. Since γ-alumina, from which a coarse particle component has been removed, is used, recording media excellent in ink absorbency and capable of forming images high in optical density can be produced.

What is claimed is:

1. A recording medium comprising a base material and an ink-receiving layer containing a particulate material provided on the base material, wherein the particulate material comprises aluminum oxide particles of the γ-crystal structure, the average particle diameter of the aluminum oxide particles is at least 0.21 μm, but at most 1.0 μm, at least 90% of all the aluminum oxide particles have a particle diameter of at most 1.0 μm, and the specular glossiness of the surface of the ink-receiving layer is at least 50% as measured at 75°.

2. The recording medium according to claim 1, wherein at least 70% by weight of the particulate material is aluminum oxide particles of the γ-crystal structure.

3. The recording medium according to claim 1, wherein at least 90% by weight of the particulate material is aluminum oxide particles of the γ-crystal structure.

4. The recording medium according to claim 1, wherein the ink-receiving layer comprises a binder, and a mixing ratio of the aluminum oxide particles of the γ-crystal structure to the binder is within a range of from 1:1 to 30:1 in terms of a weight ratio.

5. The recording medium according to claim 1, wherein the aluminum oxide particles of the γ-crystal structure are particles obtained by heating and calcining boehmite or pseudoboehmite.

6. The recording medium according to claim 1, wherein the aluminum oxide particles of the γ-crystal structure are particles which are produced by heating and calcining boehmite or pseudoboehmite, followed by a step of removing a coarse particle component by a grinding and separating treatment, and from which the coarse particle component has been removed.

7. The recording medium according to any one of claims 1 to 6, wherein the base material is formed of a fibrous base having a surface layer containing barium sulfate, and the ink-receiving layer is provided on the surface layer.

8. The recording medium according to claim 7, wherein the Bekk smoothness of the surface layer is at least 400 seconds, and the whiteness degree thereof is at least 87%.

9. An image forming process, comprising the step of applying a recording liquid to the ink-receiving layer of the recording medium according to claim 1 in response to recording information to form an image.

10. A process for producing a recording medium, which comprises the steps of forming coarse particles of aluminum oxide of the γ-crystal structure by heating and calcining boehmite or pseudoboehmite, removing a coarse particle component by a separating treatment after grinding the formed coarse particles of the aluminum oxide of the γ-crystal structure, and applying a coating formulation comprising the aluminum oxide particles of the γ-crystal structure, from which the coarse particle component has been removed, onto a base material.

11. The process according to claim 10, wherein the average particle diameter of the aluminum oxide particles of the γ-crystal structure is at least 0.21 μm, but at most 1.0 μm, at least 90% of all the aluminum oxide particles of the γ-crystal structure have a particle diameter of at most 1.0 μm, and the specular glossiness of the surface of the ink-receiving layer is at least 50% as measured at 75°.

12. The process according to claim 10 or 11, wherein the coating formulation comprises a binder, and a mixing ratio of the aluminum oxide particles of the γ-crystal structure to the binder is within a range of from 1:1 to 30:1 in terms of a weight ratio.
